(19) United States
(12) Patent Application Publication
(10) Pub. No.: US 2009/0010811 A1
(43) Pub. Date: Jan. 8, 2009

(54) System for Selective Illumination of Well Plates

(76) Inventors: Richard T. L. Chan, La Jolla, CA (US); Winston Glenn Walker, Littleton, CO (US); David Alvin Tyvoll, La Jolla, CA (US)

Correspondence Address: Richard T.L. Chan;David Tyvoll, P.O. Box 795, La Jolla, CA, 92038-0795, US

(21) Appl. No.: 11/773,856

(22) Filed: Jul. 5, 2007

(51) Int. Cl. B01L 3/00

(52) U.S. Cl. 422/102

(57) ABSTRACT

An illumination system enhances a manual human process associated with a multiwell plate having an array of wells thereon. The illumination system includes a compact self-contained apparatus including an illuminator coupled to a human interface. The human interface is configured to receive an operating parameter input and a start input. The illuminator has a protective surface for receiving the well plate and a plurality of underlying light sources configured to initiate a sequence of different well subarray indications in response to the start input and pursuant to the operating parameter input.

### FIELD OF THE INVENTION

The field of the invention concerns visual illumination devices for laboratory research. More particularly, the present invention concerns illumination devices to facilitate the manual use of substrates having fluid wells thereon including substrates often referred to as multiwell plates.

### BACKGROUND OF THE INVENTION

Multiwell plates are used commonly by life science researchers. “Multiwell plate,” “multi-well plate,” “wellplate”, “well plate,” “well-plate,” “microplate,” “microtiter plate” and “plate” refer to a two dimensional array of sample wells located on a substantially flat surface. Multiwell plates are typically formed from polymeric plastic materials such as polypropylene or polystyrene. In some cases, other materials such as glass are incorporated into the well plate, usually as the bottom of the well. Yet other materials such as porous materials may be used as part of the well plate, to provide a means to filter a sample. Such porous materials include glass frits, plastic frits made from polyethylene, and the like.

Multiwell plates may comprise any number of separate sample wells, and comprise sample wells of any width or depth. Common examples of multiwell plates include 96 well plates, 384 well plates, 1536 well plates and 3456 well plates. 96 well plates usually contain an 8×12 rectangular array of wells, 384 well plates contain a 16×24 rectangular array, and so on. Typically, sample wells are arranged in two-dimensional linear arrays on the multi-well platform. However, the sample wells may be arranged in other patterns as well, such as staggered arrays.

The footprint of existing multiwell plates is approximately 85.5 mm in width by 127.75 mm in length (see the Society for Biomolecular Sciences “SBS Proposed Microplate Specifications, Revised January 2001). For a standard 96 well plate, the spacing between the sample wells is approximately 9 mm from center-to-center. Sample well volumes typically may vary depending on well depth and cross sectional area. Sample well volumes may range from between about 0.5, 1, 5, 10, 25, 50, 75, 100 or 300 microliters or more.

Sample wells may be made in any cross sectional shape (in plan view) including round, square, hexagonal, other geometric or non-geometric shapes, and combinations (intra-well and inter-well) thereof. Wells may be made in any cross sectional shape (in vertical view) including shear vertical or chamfered walls, wells with flat or round bottoms, conical walls with flat or round bottoms, and curved vertical walls with flat or round bottoms, and combinations thereof.

Many well plates are made of clear plastic. But, depending on the particular assay for which the well plate was designed, the well plate may be made or coated with an optically opaque material. Alternatively, the walls or bottom of the sample wells may be opaque. Frequently the bottom of the sample well is transparent, and the walls of the sample walls are opaque. Within the bottom of a well, some regions may have high transparency and other regions may be optically opaque.

In some instances the bottom of the sample well is transparent to ultraviolet (UV) radiation. These multiwell plates are typically made from a combination of different materials, one material making up the walls of the sample wells and another material making up the bottoms of the wells. Well plates may be present either with, or without, lids. For example, a well plate may have a UV-transparent bottom and be used with a UV-blocking lid.

A substantial portion of the work with the plates discussed supra requires manual human processes such as visual observation and hand dispensing of small volumes of fluids into the wells of the plates. Such meticulous work may be challenging, particularly when the well plate is located inside a sterile hood. Sterile hoods are used to reduce the risk of contamination of the assay. The workspace under a sterile hood can be confined and poorly lit, making observation and hand dispensing with a pipette difficult. In particular for hand pipette work, clearly seeing where a specific well is located can be error prone. Other sources of human error are associated with remembering which well or group of wells have not received fluid. Such error can occur whether or not one is working under a hood.

### BRIEF DESCRIPTION OF THE DRAWINGS

FIG. 1A is a schematic diagram depicting an illumination system of the present invention.

FIG. 1B is a side view of an illumination system of the present invention.

FIG. 1C is a top view depicting an illumination system of the present invention.

FIG. 1D is an exemplary simplified cross-sectional view taken through AA′ of FIG. 1C.

FIG. 2 is an exemplary simplified cross-sectional view taken through AA′ of FIG. 1C.

FIG. 3 is an exemplary user interface utilized by the illumination system of the present invention.

FIG. 4 is a simplified plan view of a receiving surface of an exemplary illumination system with a fully illuminated well plate thereon.

FIG. 5 is a simplified plan view of a receiving surface of an exemplary illumination system with a well plate thereon wherein well A1 is visibly indicated.

FIG. 6 is a flow chart of a method of indicating a sequence of individual wells.

FIG. 7 is a simplified plan view of a receiving surface of an exemplary illumination system with a well plate thereon wherein well A1 is visibly indicated.

FIG. 8 is a simplified plan view of a receiving surface of an exemplary illumination system with a well plate thereon wherein well B2 is visibly indicated.

FIG. 9 is a simplified plan view of a receiving surface of an exemplary illumination system with a well plate thereon wherein wells of row A are visibly indicated.

FIG. 10 is a flow chart of a method of indicating a sequence of subarrays of wells.

FIG. 11 is a simplified plan view of a receiving surface of an exemplary illumination system with a well plate thereon wherein well A4 is visibly indicated and fully illuminated, and wells A1, A2, and A3 are visibly indicated and illuminated with reduced intensity or changed color.

FIG. 12 is a flow chart of a method of automatically indicating a sequence of subarrays of wells.

FIG. 13 is a flow chart of a method of adjusting a dwell time during paused state.

FIG. 14 is a plan view of a well plate 14 having a staggered array of wells 28.

### DETAILED DESCRIPTION OF THE PREFERRED EMBODIMENTS

The present invention concerns an illumination system that is configured to facilitate manual use of multiwell plates for life sciences research. Such manual use includes observation of and pipette dispensing of fluids onto the well plates.

The illumination system of the present invention includes an illuminator defining a receiving surface thereon. The surface is for receiving an object or multiwell plate. Examples of multiwell plates include 96 well plates and 384 well plates. An example of a multiwell plate supplier is Sigma-Aldrich located in St. Louis, Mo. Another is the maker of Corning Plasticware, Corning, Inc. in Corning, N.Y. A multiwell plate is a substrate (made of plastic, glass, metal, or other materials or a combination thereof) having an array of wells thereon.

An illumination system according to the present invention is a compact apparatus containing a human interface coupled to an illuminator. The illuminator and the human interface are integrated as one compact unit. The human interface includes associated features and electronics so as to receive manual inputs from a user (a researcher) and to generate control signals for operating the illuminator. The illuminator includes a protective surface for receiving a multiwell plate having an array of wells thereon. The illuminator also includes an array of underlying light sources (underlying the protective surface) that are each positioned to illuminate through a different portion of the protective surface so as to provide illumination and/or well indication visible to the user.

In one embodiment, the array of light sources includes an array of matrix light sources that each correspond to one of the array of wells. Each matrix light source is positioned to illuminate its corresponding well. The illuminator is configured to visibly indicate a subarray of the array of wells by modulating a subarray of the array of matrix light sources. A subarray is less than the entire array; a subarray is one or more of: a single well (or light source), a row, a partial row, a column, a partial column, or another group within the entire array. Modulating a light source includes one or more of activating (turning on) or deactivating (turning off) the light source, changing an intensity or luminance of the light source, changing a hue or color (spectral distribution) of the light source, causing the light source to blink (visually apparent and repeated on and off cycles), or pulse width modulation (very rapid on and off cycles that modulate apparent intensity).

Modulating a subarray of the array of matrix light sources generates an illumination contrast across the array of wells that indicates a subarray of the wells. In one embodiment, the illumination contrast is generated by illuminating wells to be indicated and leaving the remaining wells in a relatively darkened or not illuminated state. In one embodiment, the illumination contrast is generated by producing a color contrast between the subarray of indicated wells and the wells not indicated. In one embodiment, the illumination contrast is generated by utilizing a difference in modulation for the indicated subarray of wells and surrounding or adjacent or remaining wells.

In one embodiment, the array of light sources includes a plurality of index light sources that are configured to illuminate indicia that indicate rows and/or columns of well locations. In one embodiment, some indicia are illuminated letters corresponding to rows, and some are illuminated numbers corresponding to columns. A well or well location is visibly indicated when its associated indicia are illuminated.

In one embodiment, the array of light sources is configured to visibly indicate a subarray of wells via direct visible indication using the matrix light sources. In one embodiment, the array of light sources is configured to visibly indicate a subarray of wells via indirect visible indication using the index light sources. In one embodiment, the array of light sources is configured to visibly indicate a subarray of wells using a combination of direct visible indication and indirect visible indication.

The illuminator is configured to initiate a sequence of different well subarray indications in response to manual user inputs received by the human interface. A well subarray indication is either direct (as in the case of well illumination from matrix light sources) or indirect (as in the case of using row and column index light sources), or a combination thereof. The manual user inputs include a start input that starts or initiates the sequence and an operating parameter input that defines aspects of the sequence or the well indication.

In one embodiment, the sequence of different well subarray indications is a manual well indication sequence wherein a start input is required to execute or initiate each new subarray indication. Each change wherein a different subarray is indicated is referred hereinto as a well indication advancement. For a manual sequence, each advancement requires a start input.

In one embodiment, the sequence of different well subarray indications is an automatic well indication sequence wherein a single start input results in multiple advancements. Stated another way, the illuminator is configured to execute the sequence of different well subarray indications automatically based on a single start input.

The operating parameter input is defined by an operating parameter including one or more of the following operating parameters: dwell time parameter, well subarray parameter, sequence direction parameter, well indication parameter, and other parameters. The subarray parameter, sequence direction parameter, and indication parameter all apply to both manual and automatic well indication sequences. The dwell time parameter applies only to automatic well indication sequences.

A dwell time parameter defines the dwell time between pairs of different subarray indications in an automatic sequence of different well subarray indications. Stated another way, the dwell time parameter defines a dwell time between advancements in an automatic well subarray indication sequence.

The well subarray parameter defines a well subarray type to be visibly indicated from among a plurality of different well subarray types including an individual well, row, partial row, column, partial column, or another group of wells. The sequence direction parameter is indicative of the advance direction across the array of wells during a well indication sequence. The well indication parameter determines whether the well indication is indirect, direct, and/or a combination of indirect and direct well indication. Stated another way, the well indication parameter defines whether matrix light sources, index light sources, or a combination thereof are to be used for well subarray indications.

The illumination system of the present invention eliminates human error with manual dispensing processes by allowing researchers to see where dispensing has taken place and/or where dispensing needs to occur. Manual and automated sequential advancement of visibly indicated wells is particularly helpful to enable efficient, error-free hand dispensing with pipettes.

There are many possible sequences, but particularly in the case of a 96 well plate the sequence may proceed from column to column or from row to row. In the case of other well plates, for example a 384 well plate, the sequence may be considerably more complex, and involve advancement in different quadrants within the well plate.

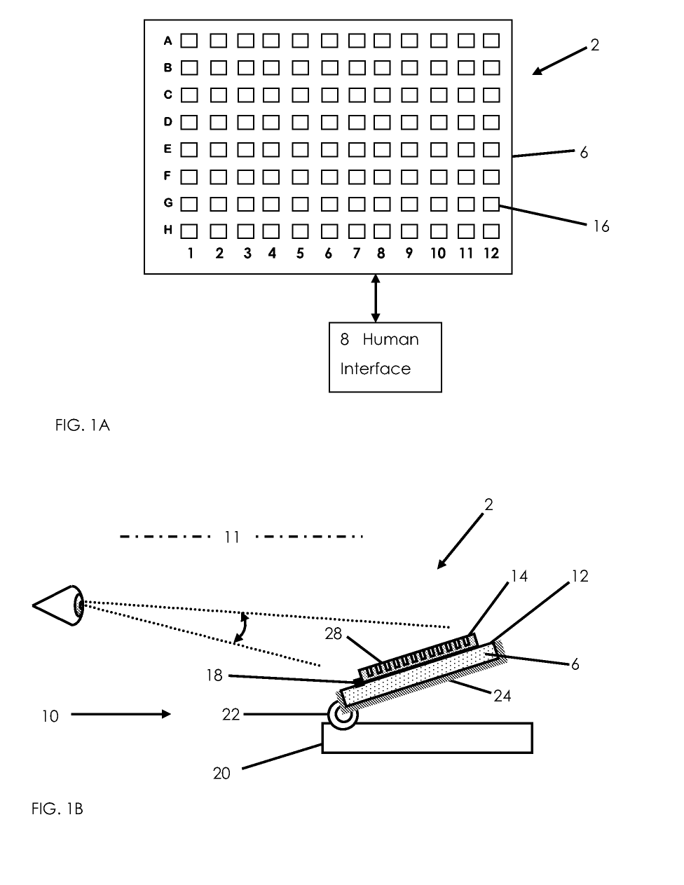

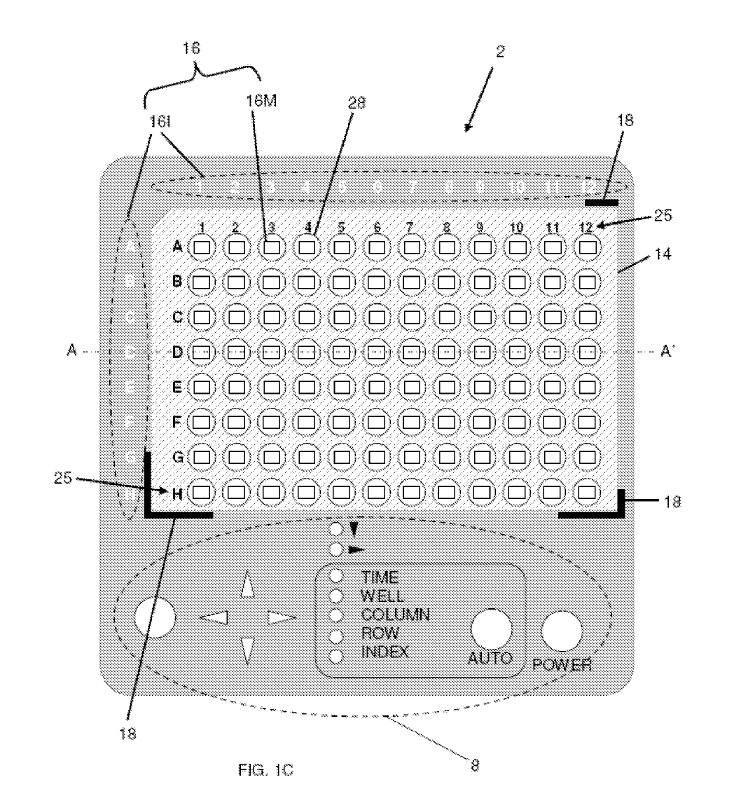

FIGS. 1A-D depict an exemplary illumination system 2 of the present invention. Illumination system 2 includes illuminator 6 coupled to human interface 8. In a preferred embodiment, illumination system 2 also includes an elevation apparatus 10 that is configured to provide an angle of inclination of an illuminator 6 relative to a horizontal axis 11. Some of these features are now discussed in greater detail.

Illumination System 2: Illumination system 2 includes a receiving surface 12 for receiving multiwell plate 14. Illumination system 2 also includes a plurality of light sources 16 that are configured to provide varying illumination or an illumination contrast across multiwell plate 14 when multiwell plate 14 is disposed upon the receiving surface 12. Some of light sources 16 may also be configured to provide selective illumination of indicia or indices that are utilized to visibly indicate rows (A, B, C . . . H in FIG. 1A) and columns (1, 2, 3 . . . 12 in FIG. 1A). We refer to the plurality of light sources utilized to illuminate the plate 14 as matrix light sources 16M and refer to the plurality of light sources to illuminate the indices as index light sources 16I.

In an exemplary 96 well plate, there are 116 light sources including 96 matrix light sources 16M and 20 index light sources 16I. One matrix light source 16M is configured to illuminate each of the 96 wells when the 96 well plate is properly positioned upon the receiving surface 12. In a preferred embodiment, at least one alignment feature 18 is provided on illuminator 6 to provide proper alignment between each matrix light source 16M and each well 28 of the multiwell plate 14.

Light Sources 16: In one embodiment, each of light sources 16 includes one or more light emitting devices such as LEDs (light emitting diodes). Including more than one light emitting device per light source 16 improves reliability of the illumination system 6 such that each light source 16 is not dependent upon a single light emitting device.

In one embodiment, each light source includes one or more LEDs emitting one or more of white, amber, red, green, blue, yellow, or another color. In one embodiment, each light source includes a red, green, and blue light emitting device to enable a wide range of output colors.

In one embodiment, each light source includes one or more LEDs emitting light of a wavelength longer than the absorption wavelengths of a material of or in the wells of the well plate. For example, a red LED emitting light at 640 nanometers is used to illuminate a visibly indicated well containing fluorescein, which is a fluorescent dye with an absorption peak of ˜490 nanometers.

In one embodiment, each light emitting device includes a UV (ultraviolet) light source. If materials of or in the wells of the well plate fluoresce in the visible region of the light spectrum (approximately 400-700 nanometers), then UV light sources will result in visible light to the researcher using the illumination system. Optionally, a lid is provided for the well plate which is opaque to UV light, to protect the user from exposure.

In one embodiment, light sources 16 include illuminated indicia or index light sources 16I. In use with a multiwell plate, each of the index light sources 16I corresponds or aligns with one of a row of wells or a column of wells. Index light sources 16I may be particularly helpful for an opaque multiwell plate 14 that does not allow direct illumination of a well 28. It may also be very important when the well 28 contains a reagent or biological substance that is light sensitive.

Human Interface 8: Human interface 8 is configured to transfer or pass control and/or power signals to illuminator 6 in response to inputs or selections received by human interface 8. Human interface 8 may be of many forms including but not limited to one or more of discrete switches or buttons, a liquid crystal display, LED based display, a touch screen display, analog dials, and rotary switches, to name a few. The description that follows describes one such human interface based upon switches or buttons for exemplary purposes.

Elevation Apparatus 10: Elevation apparatus 10 enables illuminator 6 with multiwell plate 14 to be inclined to facilitate observation during dispensing of fluids onto multiwell plate 14. This elevation apparatus 10 is particularly important when used under a sterile hood. Elevation apparatus 10 is depicted as having a base 20, a hinge 22, and a support 24 for supporting the illuminator at an inclination relative to horizontal axis 11. However, other designs are possible such as providing extendable feet on a portion that supports illuminator 6 by other mechanisms.

FIG. 1C depicts a plan view of illumination system 2 in use with multiwell plate 14 having array of wells 28. Illumination system 2 includes a plurality of light sources 16 and human interface 8. Light sources 16 include an array of matrix light sources 16M and index light sources 16I. Matrix light sources 16M are utilized to directly illuminate wells 28 and index light sources 16I are utilized to indicate wells 28 indirectly.

Each of the matrix light sources 16M corresponds to one of the array of wells 28. The array of matrix light sources 16M is aligned with the array of wells 28 using alignment feature(s) 18. Each well 28 is aligned to its corresponding light source 16 as a result of alignment feature(s) 18. FIG. 1C depicts all of the matrix light sources 16M and all of the index light sources 16I in an illuminated state.

The index light sources 16I are illuminated to visibly indicate individual wells, columns, and/or rows of wells. When a well is visibly indicated, its corresponding row index light source (from A to H) and its corresponding column light source (from 1 to 12) is illuminated. Index light sources 16I may correspond to indicia 25 that may be printed and/or embossed into multiwell plate 14. Human interface 8 is configured to receive manual user inputs that define operation of light sources 16 including the operation of matrix light sources 16M and index light sources 16I. Human interface 8 receives manual inputs from a user such as a researcher that define wells 28 or sequences of wells 28 that are to be visibly indicated. When a well is visibly indicated via human interface 8, it is visibly indicated by matrix lights sources 16M, index light sources 16I, or a combination of matrix light sources 16M and index light sources 16I. An exemplary human interface 8 will be discussed infra with respect to FIG. 3.

FIG. 1D depicts a simplified cross section of illuminator 6 taken through AA′ of FIG. 1C. Various elements of illuminator 6 have been left out for simplicity. Multiwell plate 14 is resting on receiving surface 12. Receiving surface 12 is defined by a protective layer 13. Each of a row of underlying matrix light sources 16M illuminates a corresponding well 28. Protective layer 13 is a chemically impervious layer for protecting light sources 16.

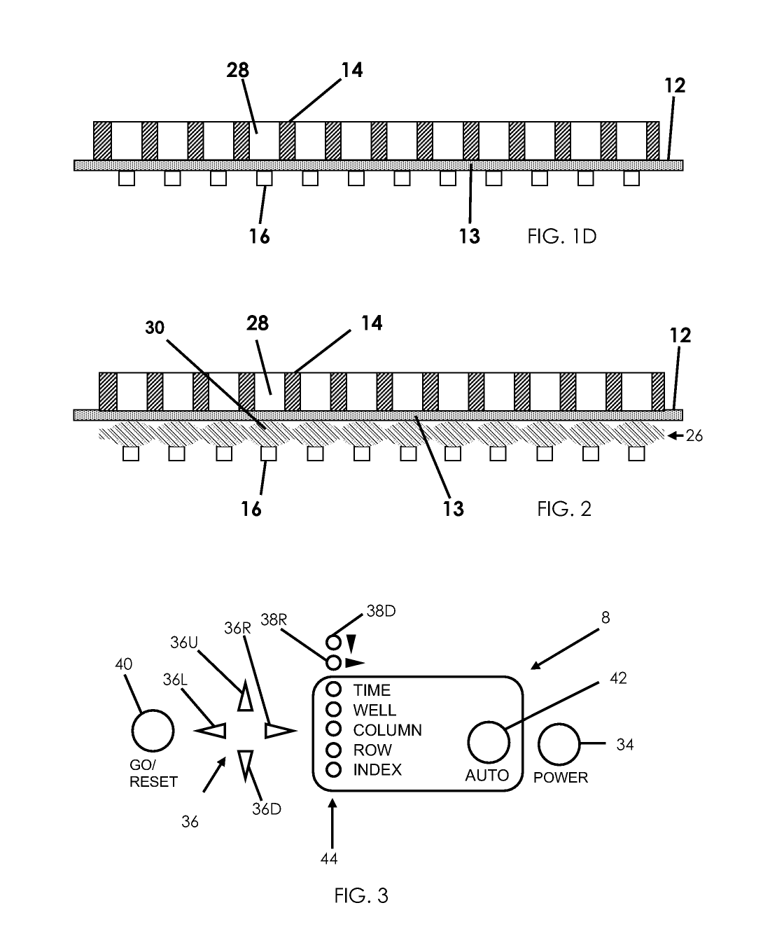

FIG. 2 depicts a simplified cross section of an alternative embodiment of illuminator 6 taken through AA′ of FIG. 1C that is enhanced by lens or optical element array 26. Some elements of the cross section have been left out and/or simplified in FIG. 2 for illustrative simplicity. Optical element or lens array 26 is configured to modulate light in order to optimize and enhance the illumination of well plate 14 by light sources 16. Modulating light according to FIG. 2 refers to either a light path (lens) effect, a spectral distribution (filter) effect, or other optical effect. In one embodiment, for each well 28 there is an associated lens 30 to direct the light from light source 16 to enable a more sharply defined or more unambiguous illumination of the well 28. In a preferred embodiment of illumination system 2, the lens array 26 is removable and replaceable such that a lens array design may be optimized for a particular well plate 14. In one embodiment, well plate 14 and lens array 26 are combined to provide a well plate that is optimized for illuminator 6.

In another embodiment, optical element 30 is not a lens but an optical filter 30 such as an optical band pass filter 30 or an optical band reject filter 30 designed to optimize the spectral distribution of light passing to the wells 28. In yet another embodiment optical element 30 combines properties of an optical filter and a lens element to modify the spectral distribution and the geometrical optical path of light passing from light source 16 to well 28.

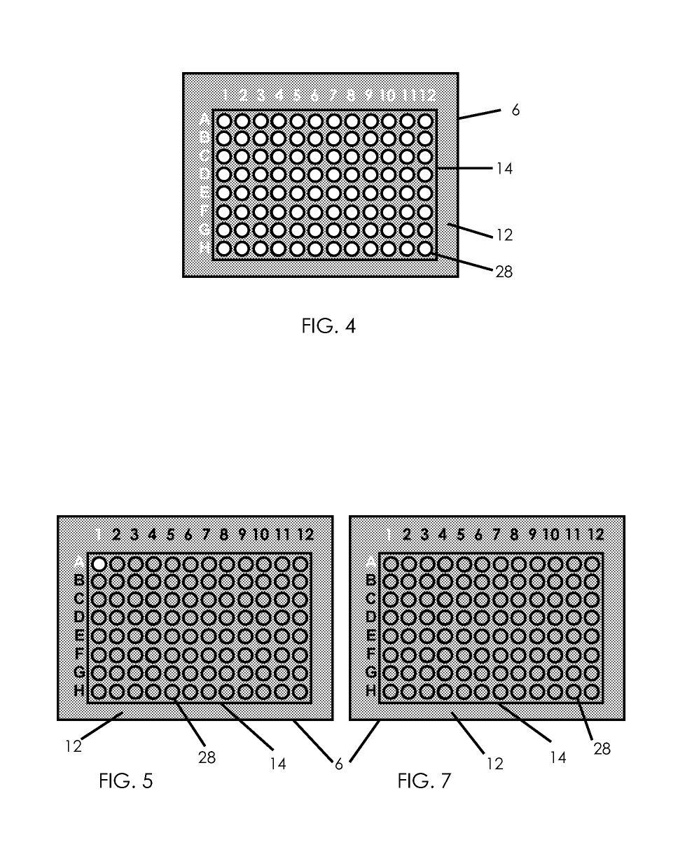

Functions of an exemplary human interface 8 will now be discussed in detail with respect to FIG. 3. FIGS. 4, 5, 7, 8, 9, and 11 depict simplified diagrams of a well plate 14 placed on a illuminator 6 to enable the visible indication of wells 28 on well plate 14. Details of the illumination system and well plate are left out for illustrative simplicity.

### Power On and Intensity Adjustment

Human interface 8 includes user accessible features that enable activation of power for illuminator 8 and for adjustment of the intensity of the light sources 16. In an exemplary embodiment, this is performed using power button 34 of human interface 8.

According to one embodiment of human interface 8, the power to illuminator 6 is activated or coupled by depressing power button 34 once. When power button 34 is initially depressed, all 116 light sources are activated (illuminated) as illustrated by simplified FIG. 4.

FIG. 4 depicts multiwell plate 14 placed upon receiving surface 12 of illuminator 6. A light source is illuminating (as indicated by white) each well 28 and each of the indicia A-H and 1-12. Subsequent depression of the power button 34 then allows adjustment of the intensity of the light sources 16 (underlying wells 28).

### Individual Well Illumination and Manual Well Indication Advancement

In a preferred embodiment, human interface 8 enables visible indication of individual wells as depicted in FIG. 5. According to FIG. 5, well A1 is visibly indicated by illuminating its corresponding matrix light source A1 while keeping the remaining light sources in a relatively reduced or off state and by illuminating index light sources A and 1.

A well indication sequence includes sequentially indicating different wells of the array of wells on plate 14. A first example of a sequence is by row or along rows. Initially, well A1 is visibly indicated. Next, well A2 is visibly indicated. This continues along wells of row A until well A12 is reached, and then proceeds to well B1. This process continues row by row until well H12 is reached. It may start again at well A1. Thus, the sequence is:

Row A: (A1, A2, A3, A4, A5, A6, A7, A8, A9, A10, A11, A12), Row B (B1, B2, B3, B4 . . . B12), Row C (C1, C2, C3 . . . C12), Row D, Row E, Row F, Row G, Row H (H1, H2, H3 . . . H12.) Optionally the sequence may begin again with A1.

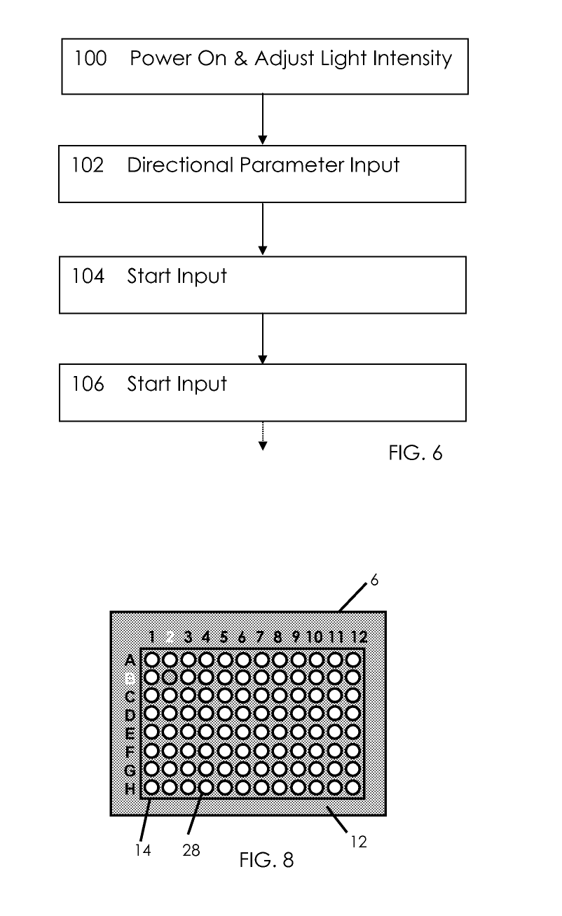

FIG. 6 depicts a process for turning on illumination system 2 and advancing a single well in a sequence. First, power button 34 is depressed once to turn the power on. The light sources 16 are initially brightest, so power button 34 is repeatedly depressed until a desired intensity level is achieved. At this point in time, all the light sources are illuminated (as depicted in FIG. 4) and indicator lights next to directional indicators 38D and 38R are alternately blinking.

According to 102, an advancement direction is selected by depressing a directional key 36R (for row by row advancement) or 36D (for column by column advancement). When one of these is depressed, the directional indicator 38D or 38R corresponding to the selected direction is illuminated and the other directional indicator is extinguished. For example, if directional key 36R is depressed, then directional indicator 38D is extinguished and directional indicator 38R glows steadily. At the same time, well A1 is indicated by its corresponding matrix light source A1 and index lights sources A and 1.

According to 104 a start input is received by human interface 8 (using GO button 40). Well indication advances to A2 in response to the start input. In one embodiment, well A1 remains indicated when well indication advances to A2. In one embodiment, light source A1 is extinguished or reduced in intensity when well indication advances to A2.

According to 106, another start input is received (via GO button 40) and well indication advances to A3. This process continues as indicated in FIG. 6 as long as preferred by the user.

A second sequence would be along columns 1 to 12 in a one-column-at-a-time manner. Initially well A1 is visibly indicated. Next, well B1 is visibly indicated. The sequence is:

Column 1 (A1, B1, C1, D1 . . . H1), Column 2, Column 3, Column 4 . . . Column 12 (A12, B12, C12 . . . H12). The sequence may begin again with A1.

Manual advancement of visibly indicated well locations may be accomplished either with directional buttons 36R and 36D or the GO button 40. Thus, a start input may be received either via go button 40 or one of directional buttons 36.

The sequence described with respect to FIG. 6 is a manual sequence of different well indications. Each advancement (from well location to well location) requires a separate start input.

### Index Indicator Only

Depicted in FIG. 5 is a well visibly indicated by its corresponding matrix light source 16M and by corresponding index light sources 16I. Thus, for visibly indicated well A1, the well itself receives direct illumination from matrix light source A1 and is also visibly indicated by index light source A and index light source 1. There may be situations in which samples to be dispensed have a light sensitivity wherein it is preferable not to have a light source directly illuminating a well. Additionally, there may be a need to use an opaque multiwell plate 14 wherein direct illumination of a well is impossible.

In these cases, the user interface has an option wherein only the index light sources 16I visibly indicate a well as depicted in FIG. 7. In this case, well A1 is visibly indicated by index light source A and index light source 1. In one embodiment, a mode of only illuminating the index light sources 16I is selected by pressing the down and left arrows of directional switch 36.

FIG. 8 depicts another mode of operation wherein well B2 is visibly indicated by its lack of illumination and the illumination of surrounding wells. All of the remaining matrix light sources are illuminated. Index light sources B and 2 are also illuminated. FIG. 8 depicts a light field mode wherein the visibly indicated well is not illuminated or has a reduced level of illumination relative to other wells.

In general, a matrix light source 16M may visibly indicate a well by creating an illumination contrast between that well and remaining or adjacent or surrounding wells. The contrast may be as a result of modulating the matrix light source so that there is a visibly apparent difference in intensity, color, blinking versus no blinking, or other effect between the visibly indicated well and adjacent or surrounding or remaining wells. An illumination contrast may be based on a discontinuity in illumination intensity, hue or color, pulse width modulation, or other visibly apparent differences between visibly indicated wells and adjacent or surrounding or remaining wells.

### Column or Row Illumination and Sequences

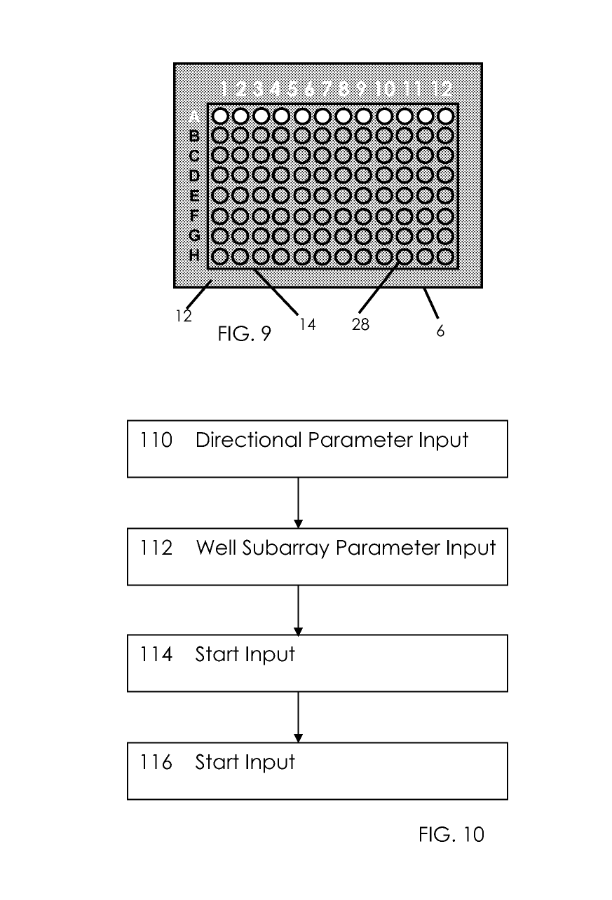

Human interface 8 enables the visible indication of a subarray of wells 28. As stated earlier, a subarray of wells may be a single well, a row or column, a partial row or column, or any other arrangement that is less than the entire array of wells. Visible indication of a row of wells 28 (row A) is depicted in FIG. 9. When a row is visibly indicated, the up 36U and down 36D buttons of the directional switch 36 may be used to visibly indicate a different row of wells. When a column is visibly indicated, the left 36L and right 36R buttons of directional switch 36 may be used to visibly indicate a different column of wells. In other embodiments, human interface 8 enables visible indication of rectangular or nonrectangular subarrays of the well arrays.

A sequence of different well subarray indications may be initiated in response to a start input and pursuant to an operating parameter input to the human interface as depicted in flow chart form in FIG. 10. According to FIG. 10, operating parameters include a directional parameter that is input according to 110 and a subarray parameter that is input according to 112. After steps 110 and 112, a first well subarray is indicated. According to 104, a start input is received, causing the well subarray indication to advance to a new well subarray pursuant to the directional input. Each advancement requires an additional start input. Stated another way, a start input is required to execute each new subarray indication.

As an illustrative example referring back to FIG. 3, element 110 is executed by depressing directional key 36D to specify a top to bottom direction of advancement. According to element 112, a row is selected as a subarray by simultaneously depressing left and right directional keys 36L and 36R respectively. Start inputs according to 114, 116 . . . are executed by repeatedly depressing the GO button 40, causing the row subgroup indication to advance down the array.

### Trailing Reduced Intensity or Otherwise Changed Well Illumination

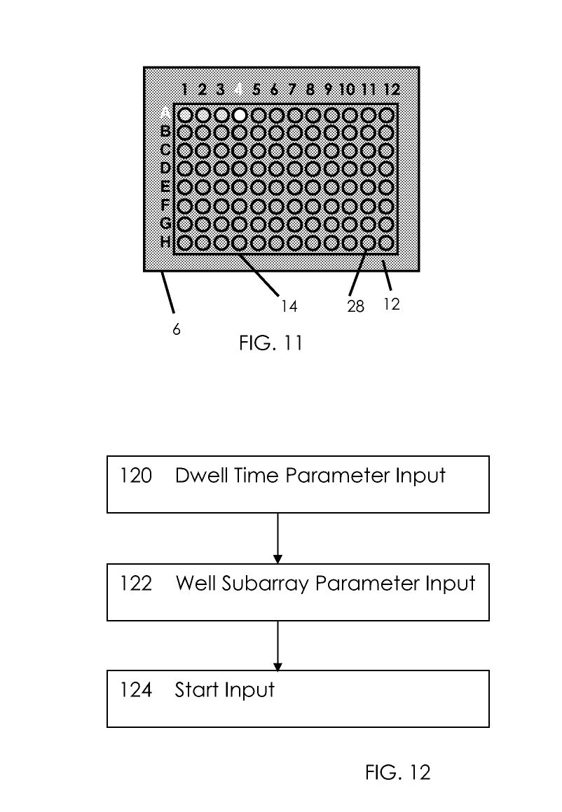

For purposes such as pipette dispensing, human interface 8 enables tracking which wells have already been visibly indicated. According to FIG. 11, well location A4 is visibly indicated by index light sources A and 4. Well location A4 is also visibly indicated via direct illumination of matrix light source A7 which is in a high intensity state relative to other matrix light sources. Wells A1, A2, and A3 have already been visibly indicated earlier in a sequence. Wells A1, A2, and A3 are still visibly indicated with matrix light sources A1, A2, and A3 respectively, but with reduced illumination intensity relative to well A4. The use of trailing reduced intensity makes the advancement direction immediately apparent to the user.

### Automatic Modes of Operation

A sequence of different well subarray indications may be either manual or automatic. One or more operating parameter inputs may define an automatic well indication sequence wherein the entire sequence is executed automatically in response to a single start input. Stated another way, a single start input executes multiple well indication advancements of a well indication sequence.

The illuminator executes the automatic well indication sequence in response to a start input and pursuant to (in accordance with) an operating parameter input. The operating parameter may include one or more of: a directional parameter, a dwell time parameter, a well subarray parameter, and a well indication parameter.

A directional parameter defines the direction of the automatic advancement of the subarray indication. The dwell time parameter defines a dwell or delay time between advancements. This is important for providing a researcher time for pipette dispensing between advancements. A researcher may adjust the dwell time according to comfort levels and preferences.

The well subarray parameter determines the type of well subarray being indicated—single well, row or column, partial row or column, or other group. The well indication parameter specifies whether well indication is direct (matrix light sources) and/or indirect (index light sources).

An exemplary process for automated operation is depicted in flow chart form in FIG. 12. According to 120, a dwell time parameter is input. According to 122, a subarray is selected. Then, according to 124, a start input is received that automatically executes the sequence pursuant to the input dwell time and subarray type.

In an exemplary embodiment of step 120, AUTO button 42 is depressed until an indicator light adjacent to TIME is illuminated (see FIG. 3). Once the indicator light adjacent to TIME is illuminated, the dwell time may be adjusted using directional keys 36. Up and right directional keys 36R and 36U increase the dwell time; down and left directional keys 36D and 36L decrease the dwell time.

In an exemplary embodiment of step 122, AUTO button 42 is depressed until the desired subarray type is indicated by one of indicator lights 44 (FIG. 3). The human interface 8 depicted in FIG. 3 enables 3 types of subarrays including individual wells, individual rows, or individual columns but other subarrays are possible within the scope of this invention. In an exemplary embodiment of step 124, the GO button 40 is depressed which executes the automatic sequence.

### Index Lights Sources Only in Automatic Mode

The AUTO button 42 may also be depressed until an indicator light is illuminated next to INDEX. When the GO button 40 (start input) is depressed the automatic well indication sequence will start with only index light sources 161 utilized.

### Pause Feature

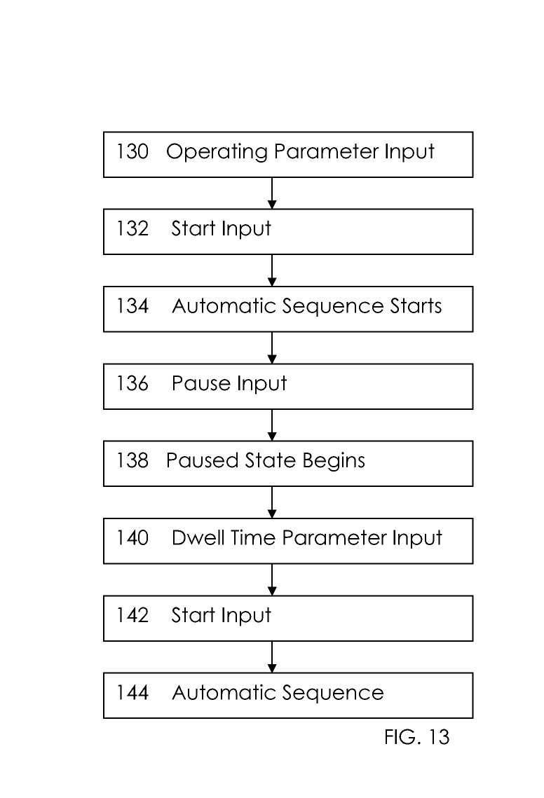

In a preferred embodiment of human interface 8, a pause feature is provided that allows a researcher to take a break, deal with a distraction, or input a new dwell time parameter. During an automatic well indication sequence, human interface 8 is configured to receive a pause input that establishes a paused state. This is depicted according to FIG. 13.

According to 130, the human interface receives operating parameter input(s) that define an automatic well indication sequence. The operating parameters may include one or more of a directional parameter input, a dwell time parameter input, a well subgroup parameter input, a well indication parameter input. According to 132, the human interface receives a start input (e.g., GO button 40) that initiates the automatic sequence according to 134. Before the sequence is complete, the human interface receives a pause input according to 136.

In one embodiment, the pause input may be a result of pushing any button of human interface 8 depicted in FIG. 3. At this point, the illumination system 2 is in a paused state according to 138. According to 140, the human interface 8 receives a dwell time parameter input. For example, this may be carried out by depressing AUTO button 42 until the TIME indicator light illuminates and then adjusting the dwell time with directional keys 36.

According to 142 a start input is received that restarts the sequence where it had stopped. According to 144, the automatic well indication sequence starts again with a new dwell time pursuant to the dwell parameter input of 140.

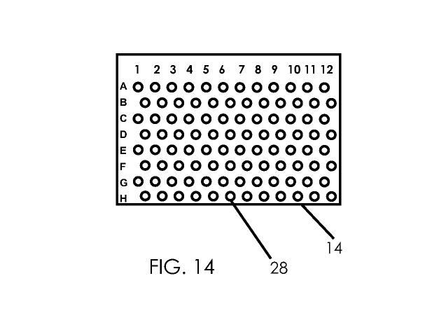

The present invention is not limited to the illustrated 96 well plates, but applies to well plates having 384 or more wells. Also, the present invention applies to well plates having staggered rows of wells 28 such as the well plate 14 depicted in simplified form with respect to FIG. 14.

The foregoing disclosure and description of the invention is illustrative and explanatory thereof. Various changes in the details of the illustrated construction may be made within the scope of the appended claims without departing from the spirit of the invention.

1. An illumination system for enhancing a manual human process associated with a multiwell plate having an array of wells thereon comprising:
a compact apparatus including a human interface integrated with an illuminator, the human interface configured to receive an operating parameter input and a start input, the illuminator including a protective surface for receiving the well plate and a plurality of underlying light sources configured to initiate a sequence of different well subarray indications in response to the start input and pursuant to the operating parameter input wherein the operating parameter defines a well subarray type.

2. The illumination system of claim 1, wherein the illuminator is configured to execute the sequence of different well subarray indications automatically in response to a single start input.

3. The illumination system of claim 2, wherein the operating parameter input defines a dwell time between pairs of different well subarray indications in the sequence of different well subarray indications.

4. The illumination system of claim 1, wherein the well subarray type is one of: a single well, a row of wells, a partial row of wells, a column of wells, a partial column of wells.

5. The illumination system of claim 1, wherein the operating parameter input is indicative of one or more of the following well subarray indications: direct illumination with matrix light sources, indirect illumination with index light sources.

6. The illumination system of claim 1, wherein the sequence of different well subarray indications is a manual sequence wherein a start input is required to execute each new well subarray indication in the sequence.

7. The illumination system of claim 1, wherein the operating parameter is a plurality of operating parameters including two or more of: a dwell time parameter, a well subarray parameter, a sequence direction parameter, an indication parameter.

8. The illumination system of claim 1, wherein the plurality of light sources includes a plurality of index light sources wherein each index light source corresponds to one of either a row of wells or a column of wells.

9. The illumination system of claim 1, wherein the plurality of light sources includes an array of matrix light sources that are each positioned to illuminate a single well when the multiwell plate is properly positioned upon the protective surface.

10. An illumination system for enhancing a manual human process associated with a multiwell plate having an array of wells thereon comprising:
a compact apparatus containing a human interface coupled to an illuminator, the human interface configured to receive an operating parameter input and a start input the illuminator including a protective surface for receiving the well plate and a plurality of underlying light sources configured to execute an automatic well indication sequence in response to the start input and pursuant to the operating parameter input.

11. The illumination system of claim 10, wherein the automatic well indication sequence includes a sequence of well indication advancements, wherein a single start input executes multiple advancements and wherein the operating parameter defines a dwell time between advancements.

12. The illumination system of claim 11, wherein the human interface is configured to receive a pause input during the automatic well indication sequence that establishes a paused state, wherein the human interface is configured to receive the operating parameter defining the dwell time within the paused state.

13. The illumination system of claim 11, wherein the human interface is configured to receive the operating parameter defining the dwell time before executing the automatic dwell time sequence.

14. The illumination system of claim 10, wherein the array of light sources includes an array of matrix light sources and a plurality of index light sources, the illuminator is configured to utilize one of the following in pursuant to the operating parameter input: (i) only matrix light sources, (ii) only index light sources, (iii) a combination of matrix light sources and index light sources.

15. The illumination system of claim 10, wherein automatic well indication sequence includes an automatic sequence of different subarray indications, the operating parameter defines whether each subarray is a single well, a row of wells, a partial row of wells, a column of wells, a partial column of wells, or another group or arrangement of wells.

16. An illumination system for enhancing a manual human process associated with a multiwell plate having an array of wells thereon comprising:
an apparatus containing an illuminator and a human interface, the illuminator including a protective surface for receiving the multiwell plate and an array of light sources each positioned to illuminate through a different portion of the protective surface, the human interface configured to receive an operating parameter input and a start input, the human interface configured to initiate a sequence of different light source subarray modulations in response to the start input and pursuant to the operating parameter input wherein the operating parameter input defines a light source subarray type.

17. The illumination system of claim 16, wherein the sequence of different light source subarray modulations is an automatic sequence of different light source subarray modulations wherein a single start input executes the entire sequence of different light source subarray modulations.

18. The illumination system of claim 17, wherein the operating parameter input defines a dwell time between different light source subarray modulations.

19. The illumination system of claim 16, wherein the subarray type is one of: a single light source, a row of light sources, a partial row of light sources, a column of light sources, a partial column of light sources, a rectangular arrangement of light sources, a nonrectangular arrangement of light sources.

20. The illumination system of claim 16, wherein the array of light sources includes an array of matrix light sources and a plurality of index light sources, the illuminator is configured to utilize one of the following in pursuant to the operating parameter input: (i) only matrix light sources, (ii) only index light sources, (iii) a combination of matrix light sources and index light sources.

21. The illumination system of claim 16 wherein the sequence of different light source subarray modulations is a manual sequence of different light source subarray modulations, a start input is required to execute each new light source subarray modulation.

22. The illumination system of claim 16 wherein the array of light sources includes index light sources that are each positioned to illuminate indicia that are viewable on or through the protective surface.

23. The illumination system of claim 16, wherein each light source is one or more of: a light emitting diode, a red light source, a green light source, a blue light source, a yellow light source, a UV light source.
